(19) United States
(12) Patent Application Publication
(10) Pub. No.: US 2014/0280091 A1
(43) Pub. Date: Sep. 18, 2014

(54) LOCATION SPECIFIC TRANSLATION AND SEARCH SERVICE SYSTEM

(71) Applicants: Denis Nasarov, Bishkek (KG); Natalia Nadel, Surrey (GB); Andrey Slobodyan, Altai Region (RU)

(72) Inventors: Denis Nasarov, Bishkek (KG); Natalia Nadel, Surrey (GB); Andrey Slobodyan, Altai Region (RU)

(21) Appl. No.: 13/843,453

(22) Filed: Mar. 15, 2013

(51) Int. Cl. G06F 17/30

(52) U.S. Cl. CPC G06F 17/30241
USPC 707/723

(57) ABSTRACT

A hand held device acquires GPS data and connects to an Internet based remote server that uses Internet resources to obtain the location of the user and places the user in a local map which may be in a foreign country. The user may enter a particular location of interest and the hand held device communicates this request to the remote server and performs an Internet search for service providers, and provides phrases most commonly associated with the type of service provider. When a text is typed in a text box, the remote server uses Internet based translators and the community of other users of the App to translate the text into local language according to GPS or other location positioning data. The remote server uses speech features of the translator software to create and send a sound file to the hand held device. Both translated text in the local language and speech patterns enable communication with a local person. Additionally the App allows the user to learn a language through repetition, association and testing.

### 1. FIELD OF THE INVENTION

The present invention relates to computer aided positioning systems; and, more particularly, to a location specific translation and search system using an Internet and GPS enabled handheld device operable in domestic and foreign countries in conjunction with an Internet based cloud server.

### 2. DESCRIPTION OF THE PRIOR ART

Various types of Internet enabled handheld devices are available wherein a web browser may be used to find local information. Alternatively, GPS units are available that provide local map service and display driving instruction. No devices for finding a location of interest provide a user of a hand held device with the location of specific services while, at the same time, offering foreign language phrases which may be commonly associated with the searched item. Moreover, previously known hand held devices do not provide an instant translation of information through online dictionaries whilst enabling the user to ask the worldwide community of users for a translation of a phrase which is not included in the database of phrases. Furthermore, none of the previous inventions offer the above mentioned capability coupled with learning functionality, which allows users to learn a multitude of foreign languages whilst a default language for translation would be the “home” language determined by the user and the “current” language determined by the user's geographic location.

U.S. Pat. No. 4,949,268 to Nishikawa, et al. discloses a land vehicle navigation system. This land vehicle navigation system is adapted to display the present position of a vehicle by receiving signals from a combination of satellites under the global positioning navigation system. The present position of the vehicle is displayed on a screen, superposed over map data. To obtain the best global positioning data, the combination of satellites is selected in connection with the visibility. To perform the positive reception of signals from the satellites as the vehicle is running in an urban area, data relating to the building height around the area can be obtained from a geographical information section including data indicative of the map and the building height distribution with respect to the area to determine the visibility. The system uses illuminated satellites to estimate the pseudo position of the land vehicle, which is moving. The system is mounted on a moving vehicle and is not a hand held device with GPS connectivity. The GPS data is not communicated to a remote server to obtain current local position of the user and obtain local street maps and obtain local points of interest.

U.S. Pat. No. 5,802,492 to DeLorme, et al. discloses a computer aided routing and positioning system. This computer aided routing and positioning system (CARPS) determines a route along selected waypoints that include a travel origin and a travel destination and intermediate waypoints there between. The selected waypoints may be uploaded to or downloaded from various geocoding devices that utilize the Global Positioning System (GPS). A CARPS database incorporates travel information selected from a range of multimedia sources about the transportation routes, waypoints, and geographically locatable points of interest (POIs) selected by the user along the travel route. The CARPS software permits user selection of specified POI types within a user-defined region of interest and user selection of particular POIs from the selected types within the region of interest. The transportation routes, waypoints, POIs and region of interest are identifiable in the computer by coordinate locations of a selected geographical coordinate system. The CARPS software is constructed to present a user-customized travel log for preview on the computer display of the user-defined travel route. The travel planner can preview on the computer display a multimedia travelog particularly customized for the user-defined travel route including multimedia information on the transportation routes, waypoints, and POIs selected by the user. The user can engage in an iterative trip planning process of revising the route and previewing travel logs of revised travel routes until a satisfactory travel route is determined. Hardcopies of customized travel maps of the user-defined travel route can be used in conjunction with a GPS device, which has been uploaded with selected waypoint data. The system uses multimedia information in addition to positioning features so that a user may go through a way point or not go through a previously selected way point. The system is mounted on a moving vehicle and is not a hand held device with GPS connectivity. The GPS data is not communicated to a remote server to obtain current local position of the user and obtain local street maps and obtain local points of interest.

U.S. Pat. No. 5,848,373 to DeLorme, et al. discloses a computer aided routing and positioning system. This computer aided map location system (CAMLS) provides correlation and coordination of spatially related data between a computer (PDA/PC/EC) and a set of printed maps typically printed on paper depicting surface features at desired levels of detail. A first set of constant scale printed maps substantially coincides with or is overprinted with equal area grid quadrangles of a first scale grid. The first scale grid quadrangles are identified by a first set of unique names. The PDA/PC/EC has a computer display or other computer output, a first database, and display subsystem. The first database includes the first set of unique names of the grid quadrangles of the first scale grid. The boundary lines of the respective first scale grid quadrangles are identified in the first database by latitude and longitude location. The display subsystem causes the display of a selected grid quadrangle or gridname on the PDA/PC/EC display in response to a user query. The displayed grid quadrangle or gridname is correlated with a grid quadrangle of a printed map from the first set of printed maps. The PDA/PC/EC may have access to a second database or multiple databases of latitude and longitude locatable objects (loc/objects) for display on selected grid quadrangles. Alternatively or in addition the PDA/PC/EC may incorporate a user location system such as a GPS location system for displaying the location and route of the CAMLS user on the display. Multiple level scales of grids and corresponding multiple sets of maps at the different scales are available. Communications links are provided between CAMLS computers and CAMLS users in various combinations. The computer aided routing and positioning system uses GPS together with a PDA to display the location of the user on the screen and is required to correlate this indicated position in a paper map. Points of interest need to be recovered from an internal database of the PDA based on internal memory availability. The system is a hand held device with GPS connectivity, but the GPS data is not communicated to a remote server to obtain current local position of the user and obtain local street maps and obtain local points of interest.

U.S. Pat. No. 6,321,158 to DeLorme, et al. discloses integrated routing/mapping information. This Integrated Routing/Mapping Information System (IRMIS) links desktop personal computer cartographic applications to one or more handheld organizer, personal digital assistant (PDA) or “palmtop” devices. Such devices may be optionally equipped with, or connected to, portable Global Positioning System (GPS) or equivalent position sensing device. Desktop application facilitates user selection of areas, starts, stops, destinations, maps and/or point and/or route information. It optionally includes supplemental online information, preferably for transfer to the PDA or equivalent device. Users' options include route information, area, and route maps. Maps and related route information are configured with differential detail and levels of magnitude. Used in the field, in conjunction with GPS receiver, the PDA device is configured to display directions, text and map formats, the user's current position, heading, speed, elevation, and so forth. Audible signals identifying the next turn along the user's planned route are also provided. The user can pan across maps and zoom between two or more map scales, levels of detail, or magnitudes. The IRMIS also provides for “automatic zooming,” e.g., to show greater detail or closer detail as the user approaches a destination, or to larger scale and lower resolution to show the user's overall planned route between points of interest. The IRMIS also enables the user to mark or record specific locations and/or log actual travel routes, using GPS position information. These annotated location marks and/or “breadcrumb” or GPS log data can be saved, uploaded, displayed, or otherwise processed on the user's desktop geographic information or cartographic system. The IRMIS application and data may be distributed online and/or in tangible media in limited and advanced manipulation formats. This integrated routing/mapping information system uses GPS together with a PDA to display the location of the user on the screen and is required to correlate this indicated position in a paper map, a desk top computer. Points of interest need to be recovered from an internal database of the PDA based on internal memory availability. The system is a hand held device with GPS connectivity, but the GPS data is not communicated to a remote server to obtain current local position of the user and obtain local street maps and obtain local points of interest.

U.S. Pat. No. 8,106,818 to Bhattacharya, et al. discloses positioning system and positioning method. This invention performs positioning at the proper positioning time and positioning precision in response to a requirement with respect to positioning. A positioning server 10 comprises a first positioning component 12 that performs positioning of a cellular terminal 20 by a hybrid algorithm 1, in which indoor/outdoor determination is performed on the basis of reception state information indicating the reception state at the cellular terminal 20, and in which an end condition is determined on the basis of the result of the indoor/outdoor determination; and a second positioning component 13 that performs positioning of the cellular terminal 20 by a hybrid algorithm 2, in which the approximate position of the cellular terminal 20 is calculated on the basis of reception state information indicating the reception state at the cellular terminal 20, and in which whether or not to end the positioning of the cellular terminal 20 is decided on the basis of the precision of the approximated position. This system uses GPS data together with position of cellular terminal to have better estimates of the user position. The system does not procure points of interest locations or provide translation of typed text in a foreign language where a user is located.

U.S. Pat. No. 8,374,784 to Mazlum, et al. discloses system and method for determining the geographic location of a device. This method and apparatus estimates a location of a device. For each of a plurality of locations of a device, a set of positional data is determined from signals received from a plurality of satellites. The positional data is filtered and compared with data from a road network database. This comparison may be a function of a distance from at least one point defined by a set of the filtered positional data to a road in the road network database and an angle between a line representing a best fit for plural points defined by corresponding plural sets of the filtered positional data to a line defined by a road in the road network database. This system for determining the geographic location of a device uses raw GPS data or other positional data and applies filtering algorithms to correct the accuracy of the positional data for example using road latitude and longitude values. The system does not procure points of interest locations or provide translation of typed text in a foreign language where a user is located.

U. S. Published Patent Application No 20090177382 to Alles; Martin, et al discloses calibration of a navigation system. This method and apparatus is designed for correcting position error in a navigation system. A first set of positioning measurements of a device are determined from signals received from a first plurality of sources and a second set of positioning measurements of the device are determined from signals received from a second plurality of sources. A database comprising map-related information of a predetermined region is provided and a location of the device as a function of the first and second set of positioning measurements and selected map-related information is estimated. Errors in future estimated locations in a navigational system may be compensated by determining a divergence of the second set from the first set of positioning measurements. A navigational system that refines its accuracy over time is demonstrated whereby current estimates of location may be improved and data mapping utilized for future location estimates may be updated. This application is a continuation in part of the application, which issued as U.S. Pat. No 8,374,784 to Mazlum, et al. The system does not procure points of interest locations or provide translation of typed text in a foreign language where a user is located.

Based on the foregoing, there exists a need in the art for a compact hand held device with GPS capability and Internet capability that connects with a remote Internet based cloud server device that (i) knows precisely where the user is located; (ii) provides local maps and finds points of interest; and (iii) provides local language translation of a typed text with speech capability, so that these, as well as a multiplicity of additional related functions are provided by a single hand held device.

### SUMMARY OF THE INVENTION

The present invention provides a location specific translation and search service system that is easy to carry and use, and provides a functionality for learning a multitude of foreign languages. The system comprises a hand held device that has GPS (or other location methodology) capability and Internet connectivity. An ‘App’ present in the hand held device allows commutation between the hand held device and a remote Internet based cloud server accessible through the Internet. The hand held unit sends GPS (or other location methodology) latitude and longitude data to the remote server, which accesses the Internet based mapping software to determine the current location of the user and map details in the proximity of the user. This information is sent to the hand held device as a graphic file by the remote server. The user may request location specific information such as points of interest including specific food service providers and other specific service providers. Once again this information is conveyed to the remote server, which obtains location data from map services as well as other Internet based services. This information is mapped on the graphic map image and transmitted to the user's hand held device. The user may select a particular service provider and the App offers phrases which would be most commonly associated with the type of the service provider. In addition to the mapping and location specific services, the system also provides speech translation capability. Since the remote server already knows the exact location of the user by the GPS coordinates, the server knows the local language required for the translation service. The ‘App’ presents the user with a text dialog box within which the user types a text or question that needs to be communicated to a local person. The typed text checked against the database of phrases which is stored on the handheld device. If a particular phrase is unavailable from the database, a user may ask the “community” (other users of the App) for help with translation of a phrase. The phrase is forwarded to the remote server by the ‘App’ of the hand held unit and the remote server uses Internet based translation services such as translate.google.com to obtain immediate translation in the local language. As soon as the desired phrase is translated by the community it is also displayed on the device and is added to the database of phrases. This data of translated text is captured as a graphic file and transmitted to the hand held unit. The user may show the screen of the hand held unit to a local person displaying the graphic image of the translation in the local language. Additionally, the remote server may transmit to the hand held unit either an audio file or a code for playback by the handheld system as a sound file. The user may play the sound file when the graphic image of the translated text is shown to a local person. This procedure enables communication between a user and a local person even when the user is not proficient in the foreign language. Furthermore, a user can use the learning capability of the App to learn phrases and words of the desired language (learning includes repetition, association and testing).

Briefly stated, the present system provides a simple effective hand held device that is operative to search for areas of interest and associated phrases in countries throughout the world as well as displaying local map in the proximity of the user. The user may additionally receive data on specific types of service providers in the vicinity of the user. The user may type a text or a question, which is translated to text in the foreign language by the remote server. Additionally, the remote server may capture a sound file wherein the foreign language text is spoken; and this sound file is transmitted to the hand held device.

The key feature of the invention is a hand held device that has GPS and Internet capability, acquires the current location of the user, displays the street map of the local neighborhood and shows the exact location of the user using the connectivity of the hand held device to a remoter server which may be in the cloud using Internet connectivity. At this stage, the user may request a point of interest such a restaurant, bar, shopping center, hospital, dental office and the like and the information is communicated to the remote server. The remote server sends a graphic image of the local street map indicating the requested point of interest. Additionally, the user may request a translation of a typed text within a display field in the screen generated by the ‘App’. The hand held device communicates the typed text to the remote server which uses the GPS coordinates of the user to determine the foreign language, searches internal database of phrases for any matches and if the requested phrase is not available uses Internet based software to translate the typed text before asking the community to provide the translation. A graphic representation of the translated text in the foreign language is sent to the hand held device and is displayed on the screen of the device. The user can show the screen of the hand held device to a local person communicating the desires of the user without having to be proficient in the foreign language. In addition, the App provides a “learning” function enabling a user to study the foreign language of choice. It is important to note that every time the App has Internet connectivity it synchronizes the database of phrases on the hand held device with the server thus phrases (if not real time translation) are always available even when internet connectivity is absent.

Significant advantages are realized by practice of the present invention. In its preferred embodiment, the location specific translation and search service system of the present invention comprises:

i) A hand held device carried by a user having Internet connectivity and GPS capability;

ii) said hand held device having an ‘App’ that when launched establishes communication between said hand held device and a remote server comprising a cloud based Internet device;

iii) said hand held device acquiring the GPS coordinates of the user in a current location which may be within the country or in a foreign country and communicating said GPS data containing longitude and latitude coordinates that define the current location of the user;

iv) said remote server transmitting the local map data to said hand held device, and said local map being displayed on the screen of the hand held device along with exact location of the user;

v) said user requesting said remote server for location of food and other services proximal to the location of the user;

vi) said ‘App’ communicating said user request to a remote server, which uses Internet based services to locate service providers and overlays this information on the map data, and sending the graphical information to the hand held device;

vii) the user selecting a particular provider location and the hand held device communicating this information to the remoter server to enter the list of phrases most commonly associated with the type of searched service provider;

viii) said user additionally requesting the “App’ for translation services of phrases which are not part of the database at which point a separate text box is presented within which the user enters a text or question and the hand held device forwards this entered data to the remote server;

ix) said remote server, having established local GPS coordinates of the user, knowing to what language the typed text inquiry should be translated and reaching to Internet based translation services such as translate.google.com and others to obtain translation of the text in the local language and storing the printed translation data as a graphic file and forwarding it to the hand held device;

x) said requested phrase which is not in the database being also posted for translation by the members of the community (other App users who have the local language selected as their home language);

xi) said user showing the screen containing the translated text in the local language to a local person to thereby communicate information without need to be proficient in the local language;

xi) said remote server using the translation software to speak the translated phrase in the local language and capturing a sound file and forwarding it to the hand held device;

xii) said user playing the sound file when the screen with the displayed translated text is shown to a local person;

xiii) said App having a separate section in which a user can learn the language of choice through association, repetition and testing

Whereby the hand held device with GPS and Internet capability works in concert with an Internet based remote server to provide location and map information as well as points of interest close to the user location, and language translation capability.

### BRIEF DESCRIPTION OF THE DRAWING

The invention will be more fully understood and further advantages will become apparent when reference is had to the following detailed description of the preferred embodiments of the invention and the accompanying drawing, in which:

FIG. 1 illustrates at 100 the general architecture of the location specific translation and search service system;

FIG. 2 illustrates at 200 the screen of the hand held device indicating the local map and the exact position of the user;

FIG. 3 illustrates at 300 the location of a user requested location in the screen of the hand held device;

FIG. 4 illustrates at 400 the display of answers relating to the asked question; and

FIG. 5-FIG. 8 are screen shots illustrating displays related to the asked questions.

### DETAILED DESCRIPTION OF THE INVENTION

This invention relates to a location specific translation and search service system. The system comprises a hand held device that has GPS capability and Internet connectivity. This hand held device operates in coordination with a remote Internet based cloud server that has ability to acquire requested information from various Internet sources. Since the remote server does all the work, the user does not have to perform Internet searches for local maps, points of interest and the like. An ‘App’ present in the hand held device. The ‘App’ allows commutation between the hand held device and a remote server accessible through the Internet. The hand held unit sends GPS latitude and longitude data to the remote server. The remote server uses the paired data of latitude and longitude to accesses the Internet based mapping software to determine the current location of the user and map details in the proximity of the user. This map information is sent to the hand held device as a graphic file by the remote server. The user may request location specific information such as points of interest including specific food service providers and other specific service providers. This request is typed in a text box and this information is sent to the remove server. Once again this information is conveyed to the remote server, which obtains location data from map services as well as other Internet based services. This information is mapped on the graphic map image and transmitted to the user's hand held device. The user may select a particular service provider which will direct the user to the section containing common phrases associated with the type of service provider.

In addition to the map and location specific services, the system also provides speech translation capability. Since the remote server already knows the exact location of the user by the GPS coordinates, the server knows the local language required for the translation service. The ‘App; presents the user with a choice of phrases associated with the type of service provider. If a phrase is not included in the database, the user is presented with a text dialog box within which the user types a text or question that needs to be communicated to a local person. The typed text is forwarded to the remote server by the ‘App; of the hand held unit and the remote server uses Internet based translation services such as translate.google.com to obtain an immediate translation in the local language. Furthermore, the server sends a request to other community members (users of the App) who have the local language selected either as their home language. First, translation data from the Internet based translation service is captured as a graphic file and transmitted to the hand held unit. As soon as the community has provided the desired translation, the user receives a notification of the translation and the translation is stored in the database. The user may show the screen of the hand held unit to a local person displaying the graphic image of the translation in the local language. Additionally, the remote server may capture a sound file as the translation web program speaks the translated text and forward a sound file to the hand held unit. The user may play the sound file when the graphic image of the translated text is shown to a local person. This procedure enables communication between a user and a local person even when the user is not proficient in the foreign language.

User then has the option to rate whether a particular phrase from the database or a phrase translated by the community has been useful or not (similar to “like” or “dislike” functions). Useful phrases are prioritized in the database of phrases whilst phrases which have been found to be not useful or “disliked” are downgraded and ultimately removed from the database.

The following paragraph describes the elements that cooperate in concert to enable operation of the system. The hand held device is GPS capable and has Internet connectivity. It may be a tablet device such as an Apple Ipad, Acer Iconia, Samsung Galaxy tablet, Microsoft Surface tablet, Amazon Kindle, Toshiba Excite and the like. It may also be a smartphone such as an Apple Iphone, Android device such as Samsung Galaxy III, a Blackberry or a Windows based smartphone and the like. The hand held device has a custom programmed ‘App’ in the IOS (Apple), Blackberry, Windows mobile and/or Android (Google) platforms amongst others.

FIG. 1 illustrates at 100 the general architecture of the location specific translation and search service system. In this FIG. 101 is the hand held device with a specific ‘App’, not shown. 102 is a GPS satellite communicating with the hand held device providing X and Y coordinates of the user information, This information is communicated to remote server 103, an Internet based device or a cloud device using Internet connectivity. The remote server 103 contacts web map services 104a to determine the exact position of the user and obtain Local Street maps. This graphic information is transmitted to the screen of the hand held device 101. At this time the user may request specific services within the local proximity. This request is sent to the remote server; it accesses local service data base 104b and overlays local service provider information on the displayed map data. The user may select one of the providers. The user may require translation of a particular typed text. The ‘App’ provides a text box for typing. The typed information is communicated to the remote server 103, which first checks the database of phrases 104a and if the phrase is not present then contacts the language translation Internet based software at 104c and the “community” (other users of the App who have the local language selected as their primary or home language) at 104d. Since the remote server 103 knows the exact location of the user and thus the local language, the software at 104c converts the typed text to proper local language and a graphic image of the translation is captured by the remote server and transferred to the hand held device. As soon as the translation provided by 104d is available it is also transferred to the hand held device. This graphic file appears on the screen of hand held device 101 and may be shown to a local person enabling communication. Additionally, the remote server may capture a sound file when Internet software 104c speaks the foreign language translation and may be captured as a sound file and sent to the hand held device 101. The sound may be played simultaneously when the screen with translated text is shown to a local person promoting communication between the user and the local person without the need for fluency in a foreign language.

FIG. 2 illustrates at 200 the remote server displaying the local map and the exact location of the hand held device. This is accomplished by the hand held unit communicating the GPS coordinates to the remote server which looks the local map from the Internet resources and send the graphic file to the hand held unit.

FIG. 3 illustrates at 300 the user typing a desired location in a text box 301. Preferably the desired location is typed in the search box at the top of the screen. Search results relating to the locations are displayed with 302. Upon clicking on each of the locations displayed at 302 the user is presented with basic information about the location at 301. By clicking the “Let's go” button 303 the user is redirected to a list of phrases commonly associated with the type of location. By pressing “Talk” button at 304 the user can select various languages. If internet connectivity is not available, the user can select various categories of phrases by pressing “by type” button at the top right hand corner of the “Walk” screen which will direct the user to the choice of category for phrases.

FIG. 4 illustrates at 400 the user being presented with a list of questions commonly associated with the type of location searched by the user. User can browse the list of questions at 401 by scrolling or through using the phrase search function at 402. If a phrase is not available through the database (stored on the hand held device and synchronized with the server) the user may ask for a phrase to be translated at 403. The requested phrase is immediately sent by the server to be translated via Internet based translation services and delivers a notification of the said translation at 404. The server also sends out a request to members of the “community” other users of the App whose home language is the same as the local language. Upon translation by the community the phrase is presented to the user in the local language at 405. The user then can either show the image of the translation on the hand held device or have the phrase pronounced device. The user then has the option to rate the usefulness and accuracy of the phrase through “like”/“dislike” functionality at 406.

FIG. 5 illustrates at 500 being presented with an option to learn the language through image association at 501, repetition at 502 and testing at 503.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1) A location specific translation and search service system comprising:
a) a hand held device carried by a user having Internet connectivity and GPS capability;
b) said hand held device having an ‘App’ that when launched establishes communication between said hand held device and a remote Internet server;
c) said hand held device acquiring the GPS coordinates of the user in a current location communicating said GPS data;
d) said hand held device communicating the GPS data to the remote server;
e) said remote server acquiring local map and the current location of the hand held device of the user and transmitting local map as a graphic file for display on the screen of the hand held device;
f) said user requesting said remote server for a particular location of interest;
g) said ‘App’ communicating said user request to a remote server, which uses Internet based services to locate service providers and overlays this information on the map data, and sending the graphical information to the hand held device;
h) the user selecting a particular provider location and the hand held device communicating this information to the remote server to obtain a list of phrases commonly associated with the type of location or service provider;
i) said user browsing the database of phrases and if a particular phrase is unavailable additionally requesting the “App’ for translation services at which point a separate text box is presented within which the user enters a text or question and the hand held device forwards this entered data to the remote server;
j) said remote server, having established local GPS coordinates of the user, knowing to what language the typed text inquiry should be translated and reaching to Internet based translation services such as translate.google.com and others to obtain translation of the text in the local language and storing the printed translation data as a graphic file and forwarding it to the hand held device; said remote server further forwarding the request for translation to members of the “community” other users of the App whose home language is the same as the local language and storing the printed translation data as a graphic file and forwarding it to the hand held device.
k) said user showing the screen containing the translated text in the local language to a local person to thereby communicate information without need to be proficient in the local language;
l) said remote server using the translation software to speak the translated phrase in the local language and capturing a sound file and forwarding it to the hand held device;
m) said user playing the sound file when the screen with the displayed translated text is shown to a local person;
n) said user being able to rate the usefulness of a particular phrase thus increasing or decreasing the phrase's priority in the list of important phrases;
o) said user being able to utilize the “Learn” function to learn the language through repetition, image association and testing
whereby said hand held device with GPS and Internet capability works in concert with an Internet based remote server to provide location and map information as well as points of interest close to the user location, and language translation capability.

2) The location specific translation and search service system as recited by claim 1, wherein said Internet server is a cloud based Internet device.

3) The location specific translation and search service system as recited by claim 1, wherein said GPS data comprises longitude and latitude coordinates that define the current location of the hand held device of the user.

4) The location specific translation and search service system as recited by claim 1 wherein the current location is within the country.

5) The location specific translation and search service system as recited by claim 1 wherein the current location is in a foreign country.

6) The location specific translation and search service system as recited by claim 1, wherein said particular location of interest location is a food and other services proximal to the location of the user.

7) The location specific translation and search service system as recited by claim 1, wherein said map data is obtained from Google maps, Mapquest or other Internet based map software.

8) The location specific translation and search service system as recited by claim 1, wherein said particular location of interest is obtained by web search.

9) The location specific translation and search service system as recited by claim 1, wherein said translation of typed text to local language is done using Internet based translation services including translate.google.com and other commercially available translators.

10) The location specific translation and search service system as recited by claim 1, wherein said speech is synthesized by translation software including translate.google.com and other commercially available translators.
